(19) United States
(12) Patent Application Publication
(10) Pub. No.: US 2006/0044949 A1
(43) Pub. Date: Mar. 2, 2006

(54) Network scan-to-removable storage media

(75) Inventor: Andrew Rodney Ferlitsch, Tigard, OR (US)

Correspondence Address: Gerald W. Maliszewski, P.O. Box 270829, San Diego, CA, 92198-2829, US

(73) Assignee: Sharp Laboratories of America, Inc.

(21) Appl. No.: 10/919,102

(22) Filed: Aug. 16, 2004

(51) Int. Cl. G11B 19/02; G11B 21/08

(52) U.S. Cl. 369/30.01; 369/47.1

(57) ABSTRACT

A system and method are provided for storing network-scanned data in a removable storage medium. The method comprises: an imaging device providing scanned image data; sending the scanned image data to a host; at the host, composing a storage job build from the scanned image data; sending the built storage job to a removable storage medium writer; and, writing the built storage job on a removable storage medium. The removable storage medium can be a floppy disk, CD, digital video disk (DVD), ZIP, removable hard drive, or Flash memory. The host may be the imaging device, an imaging device-connected apparatus such as a server, a computer, another imaging device, a digital camera, a personal digital assistant (PDA), a wireless telephone, or a tablet personal computer. The imaging device may be a scanner, MFP, fax device, digital camera, wireless telephone, or an electronic whiteboard.

### BACKGROUND OF THE INVENTION

1. Field of the Invention

This invention generally relates to digital image processing and, more particularly, to a system and method for automatically writing data into a removable storage medium, such as a compact disk (CD), from a network-connected imaging device, such as a scanner.

2. Description of the Related Art

In a conventional operation, a user scans a document into a multifunctional peripheral (MFP) for loading into the hard drive of a network-connected device, such as a personal computer. This process is an example of a network scan. However, there are circumstances when a user desires to scan from an MFP to another destination, without the requirement of permanent storage. For example, it may be desirable make a CD copy of the scanned image.

FIG. 1 is a depiction of a multi-step, or manual network scan process (prior art). Conventionally, there is no automated method to scan multiple images to a removable storage device, such as a CD burner, from an imaging device such as an MFP. Instead, the user must scan the images to a destination on a client PC, such as using scan-to-FTP process for example. The Sharp AR-N275 is an example of a MFP that supports network scanning to a client PC via FTP. Once the image(s) are stored on the client PC hard disk, the user must then go to the client PC and initiate a CD burn. Generally, this is done by starting a CD burning application, selecting the files to burn onto the CD, and specifying volume information. The CD burning application communicates with the CD burner via a CD burner driver, to burn a CD and label the volume.

It would be advantageous if an automated method existed to initiate the burning of a CD for a series of network scans, wholly from an MFP.

Additionally, it would be advantageous if the above-mentioned automatic network scan process could be tied to other document processing, such as indexing/filing.

It would be advantageous if the automatic network scan process could be used with other types of removable storage media besides CD writers.

### SUMMARY OF THE INVENTION

The present invention is concerned with an efficient method of saving scanned image data from an imaging device, such as an MFP, to a removable storage medium writer, such as CD burner, as a walkup operation from the imaging device. In this example of the invention, the MFP supports network scanning to a CD burning process on the host. The MFP may additionally have a front panel menu(s) for the ‘network scan to CD burning process’. From this menu, the user initiates the start of a CD build job. The user then scans in one or more documents. Upon completion, the user signals the end of the CD build job.

Upon initiation of the CD build job, the MFP sends a message to the CD burning process on the host. The message indicates that a new CD burn will begin. The message may also contain other information, such as volume labeling and password control, such as PDF encryption. The CD burning process may also be coupled to other processes, which may process the scanned data in parallel. For example, the scanned image data may be indexed and filed. The CD build process may also be coupled with other MFP operations, such as copy or fax.

Then, the CD burning process is begun. The scanned data may also contain additional information, such as a filename for the scanned data. Upon completion of the CD build job on the MFP, the MFP sends a message to the CD burning process that the build is complete. The CD burning process then initiates the CD burning, according to the received information and scanned data. Alternately, the CD burning process and CD burner driver may be partially or wholly incorporated into the MFP.

Accordingly, a method is provided for storing network-scanned data in a removable storage medium. The method comprises: an imaging device providing scanned image data; sending the scanned image data to a host; at the host, composing a storage job build from the scanned image data; sending the built storage job to a removable storage medium writer; and, writing the built storage job on a removable storage medium.

The scanned image data may be digital camera data or scanned image data that is accessed from imaging device storage. Alternately, the scanned image data may be a scanned document, or converted data from a source such as stored data, a digital camera, or downloads such as facsimile format data, a memory stick data, or a web page data.

The removable storage medium can be a floppy disk, CD, digital video disk (DVD), ZIP, removable hard drive, or Flash memory. The host may be the imaging device, an imaging device-connected apparatus such as a server, a computer, another imaging device, a digital camera, a personal digital assistant (PDA), a wireless telephone, or a tablet personal computer. The imaging device may be a scanner, MFP, fax device, digital camera, wireless telephone, or an electronic whiteboard.

The step of providing scanned image data typically includes: accessing a scanning menu user interface (UI); accepting a scan start command; accepting a source command; and, accepting a scan stop command. In response to selecting the scan stop command, the steps of: sending the scanned image data; composing the storage job build; sending the built storage job; and, writing the built storage job on the removable storage medium are automatically initiated.

The scanning menu UI may be embedded in the front panel of the imaging device, a locally-connected external device, network-connected external device, or a remotely-connected external device. The scanning menu UI may also be used to choose options such as destination, host build information, storage organization information, access control, compression format, encryption, output format, host coupling, or auxiliary services.

Additional details of the above-described method and a system for storing network-scanned data in a removable storage medium are provided below.

### BRIEF DESCRIPTION OF THE DRAWINGS

FIG. 1 is a depiction of a multi-step, or manual network scan process (prior art).

FIGS. 2a through 2c are schematic block diagram variations of a system for storing network-scanned data in a removable storage medium.

FIG. 3 is a depiction of an exemplary scanning menu user interface.

FIG. 4 is a depiction of source selection, made from the scanning menu UI.

FIG. 5 is a depiction of “stop scan” scanning menu UI selection.

FIG. 6 is a depiction of a network scan-to-CD burn process.

FIG. 7 is a diagram depicting an exemplary communication process associated with filing the scanned image data.

FIG. 8 depicts an FTP host communication process.

FIG. 9 depicts a proprietary host communication process.

FIG. 10 is a drawing depicting an aspect where the host is embedded in the imaging device.

FIG. 11 is a flowchart illustrating a method for storing network-scanned data in a removable storage medium.

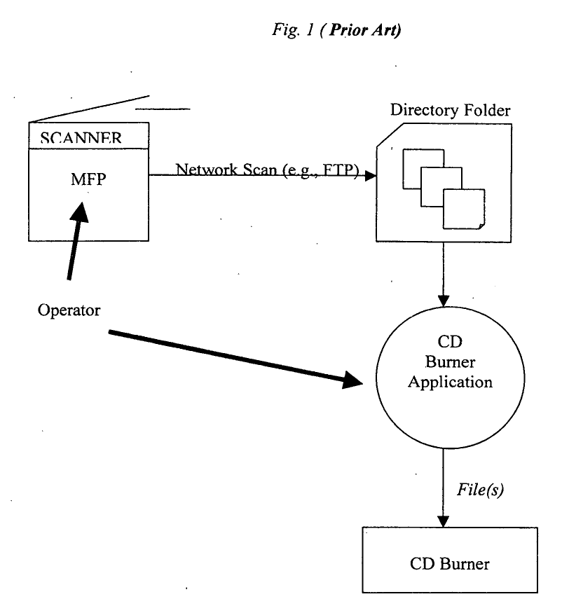

### DETAILED DESCRIPTION

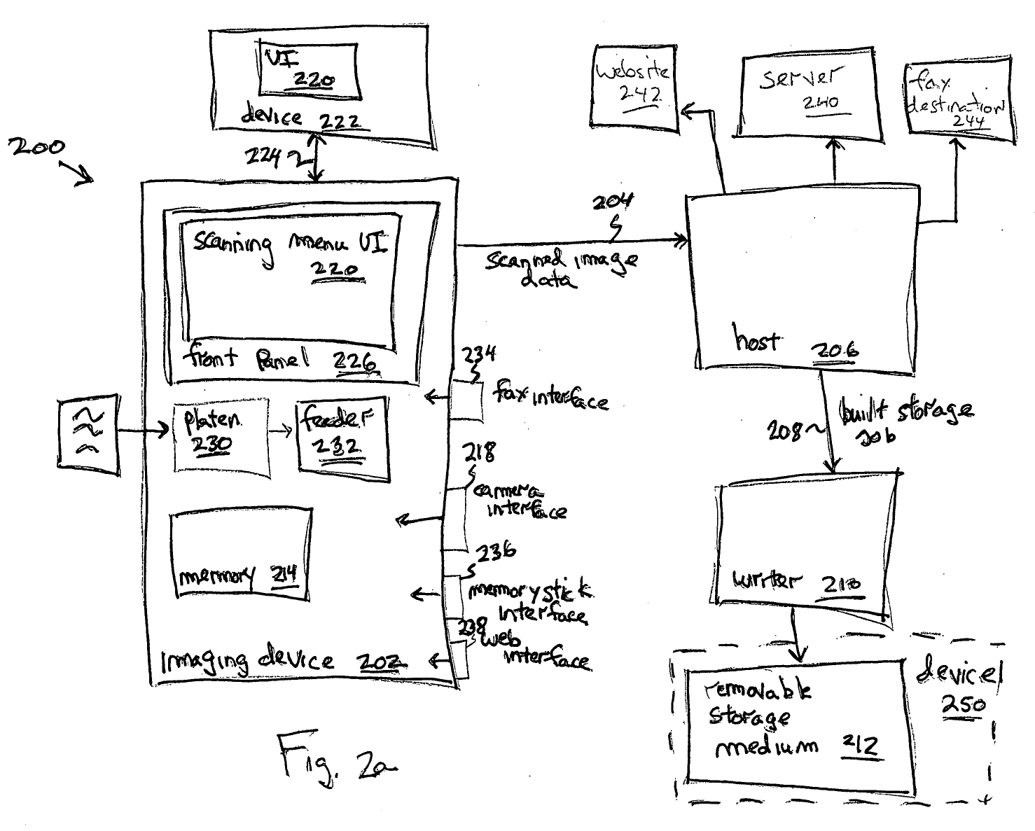

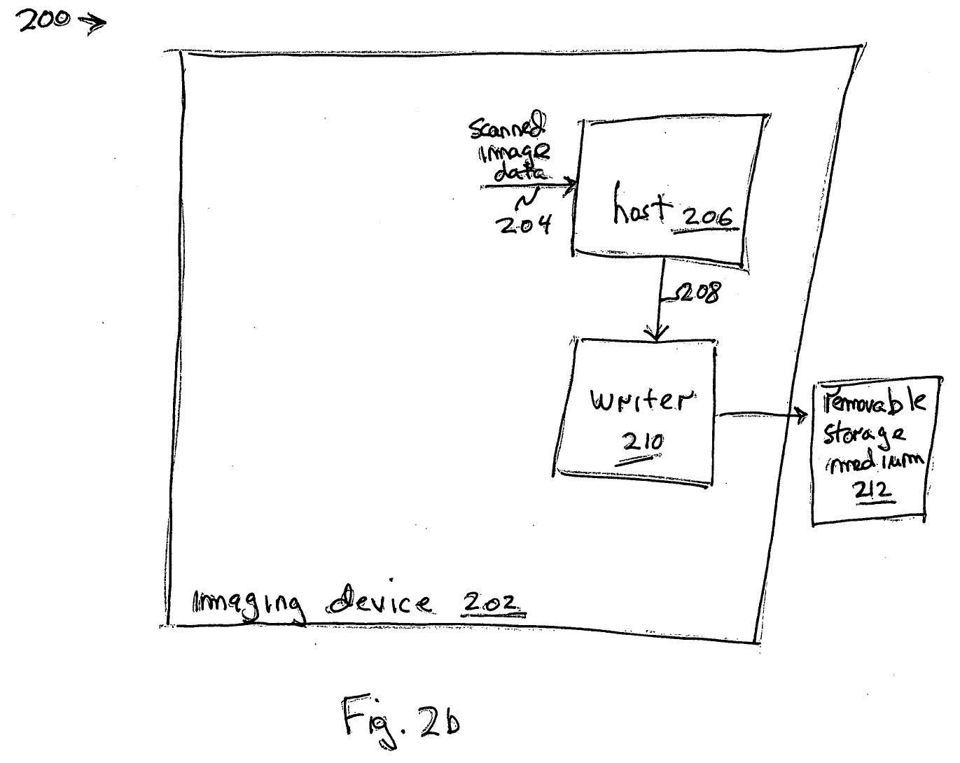

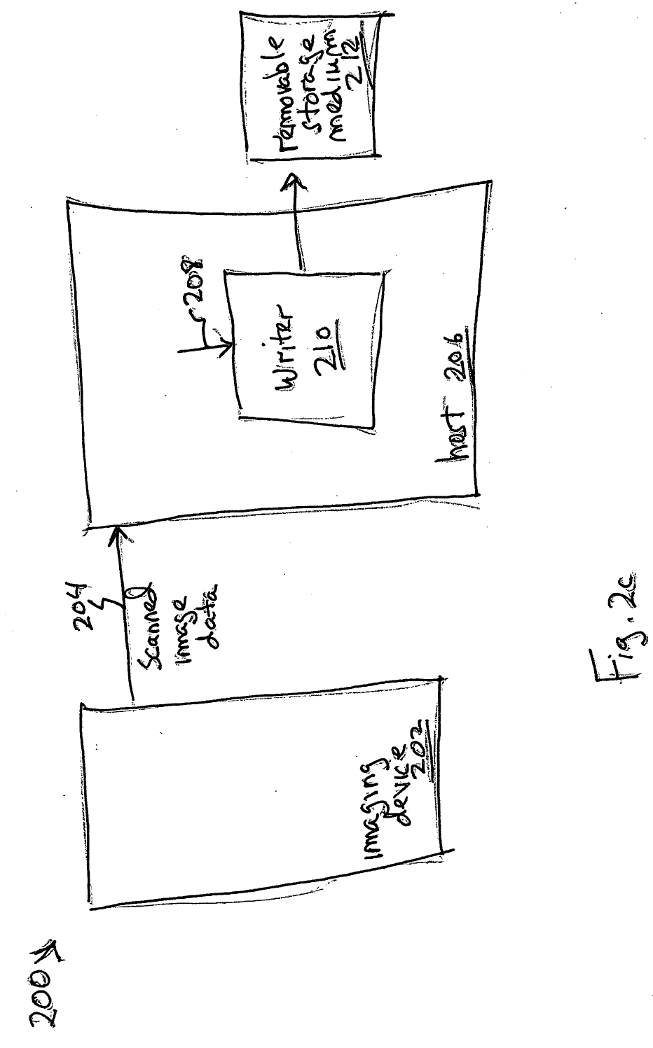

FIGS. 2a through 2c are schematic block diagram variations of a system for storing network-scanned data in a removable storage medium. In FIG. 2a, the system 200 comprises an imaging device 202 having an interface on line 204 for sending scanned image data. For example, the scanned image data may be raster data or a bitmap, or further encoded in an image format such as Tagged Image File Format (TIFF) or Portable Document Format (PDF). A host 206 has an interface on line 204 to receive the scanned image data. The imaging device 202 may send the scanned image data to the host 206 in batch mode, or synchronously. The imaging device 202 may send the scanned image data to the host 206 in a format such as file transfer protocol (FTP), email, XML/SOAP, network file system, or a proprietary format. The imaging device 202 may be a scanner, MFP, fax device, digital camera, wireless telephone, or an electronic whiteboard. For simplicity, the imaging device is typically described herein as an MFP.

The host 206 composes a storage job build from the scanned image data and sends the built storage job on an interface on line 208. The host 206 may be (embedded with) the imaging device 202, an imaging device-connected apparatus such as a server, a computer, another imaging device, a digital camera, a personal digital assistant (PDA), a wireless telephone, or a tablet personal computer.

A writer 210 accepts the built storage job on an interface on line 208, and writes the built storage job on a removable storage medium 212. The writer 210 may be embedded in the imaging device 202, the host 206, or a device 250 connected to the host 206.

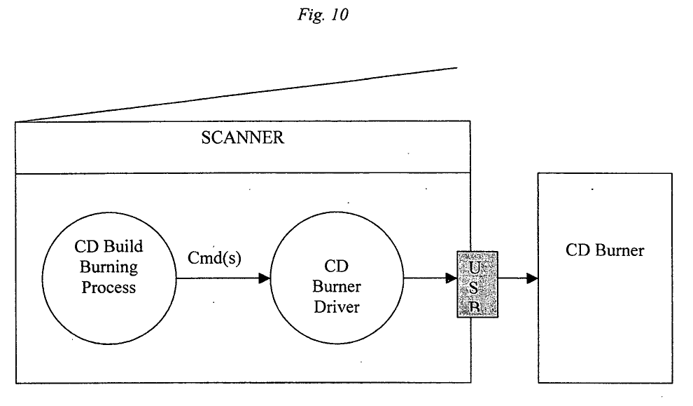

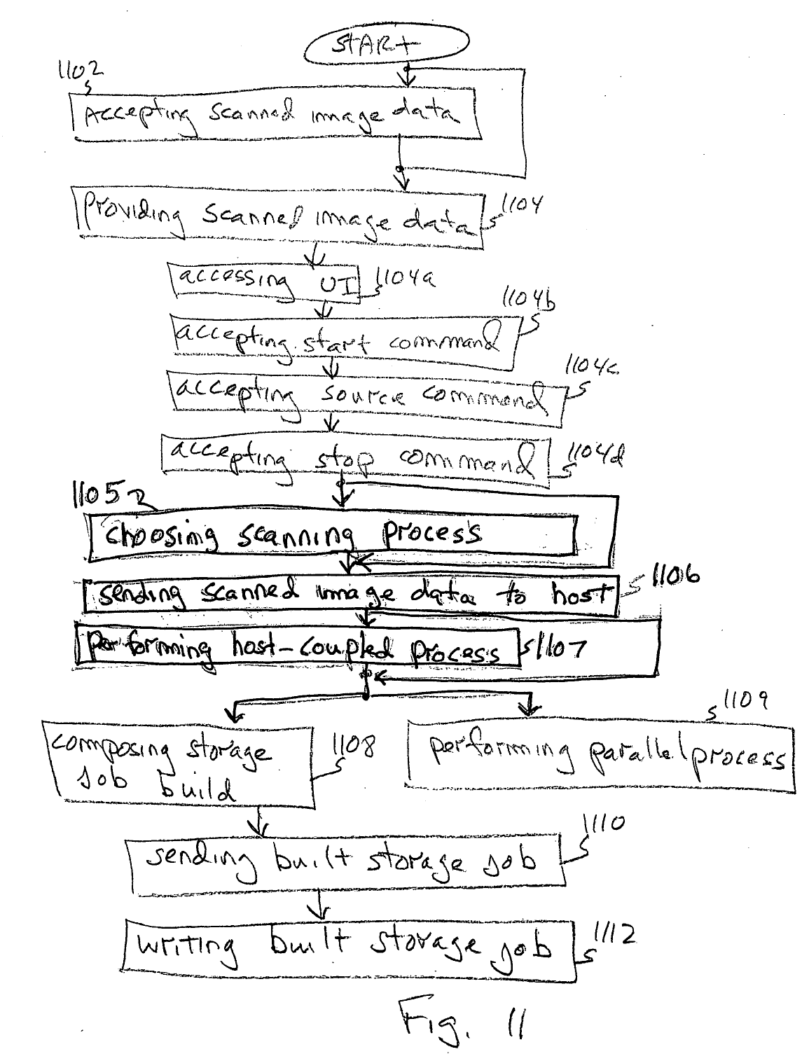

Alternately stated, the host 206 and the writer 210 may be embedded in the imaging device 202, as shown in FIG. 2b. In another aspect, the imaging device 202, host 206, and writer 210 are separate devices (FIG. 2a). In a different aspect, the imaging device 202 and the host 206 may be separate devices, with the writer embedded in the host 206, see FIG. 2c. In another aspect, the host 206 is embedded in the imaging device 202, but the writer 210 is locally connected to the host (see FIG. 10). In all of these variations, the scanning menu UI (described below) may be embedded with the imaging device 202, with the host 206, with a device connected to the imaging device 202, or with a device connected to the host 206.

In some aspects, the imaging device 202 includes a memory 214 and a camera interface on line 218. Thus, the imaging device 202 can accept digital camera data on line 218, for example, through an IrDA (Infrared Data Association) connection, or access scanned image data from the imaging device memory 214. The writer 210 may be floppy disk, CD, DVD, ZIP, removable hard drive, or Flash memory writer. However, the system 200 is not limited to any particular storage medium.

Typically, the system 200 further comprises a scanning menu user interface (UI) 220 to enable command selections such as scan start, source selection, and scan stop. For example, the UI 220 may be a liquid crystal display (LCD) and associated keypad or screen touchpad (not shown). The UI 220 can be used to initiate the automatic, or one-step feature of the invention, which permits scanned image data to be transferred and saved on a removable storage medium 212 in a single step, as seen from the user's point of view. While the invention can be implemented in many ways, the scanned data may go directly from a PC (host) ROM to a host CD burner (writer), for example, without being stored on the PC (host) hard disk.

For example, after selecting “scan start” and “source selection”, the scanning menu UI 220 accepts a “scan stop” command. The imaging device 202 automatically sends the scanned image data to the host 206 in response. Likewise, the host 206 automatically composes the storage job build and sends the built storage job in response to the scan stop command. Then, the writer 210 automatically writes the built storage job on the removable storage medium 212 in response to the scan stop command. Alternately stated, the host 206 automatically composes in response to receiving the scanned image data, and the writer 210 automatically writes in response to receiving the storage job build.

In other aspects, the scanning menu UI 220 enables option selections such as destination, host build information, storage organization information, access control, compression format, encryption, output format, host coupling, or auxiliary services. A detailed explanation of these options is presented in the Functional Description Section below.

The system 200 may further comprise a device 222 connected to the imaging device 202 through an interface 224 such as a local connection, a remote connection, or a network connection. As mentioned above, the scanning menu UI 220 may be embedded on a front panel 226 of the imaging device 202, or the device 222, or with the host 206.

In other aspects, the imaging device 202 includes a platen 230 and a feeder 232, as is conventional with many document-handling devices. Then, the scanning menu UI source selection command may be used to scan a single sheet on the imaging device platen 230, or scan a document from the imaging device feeder 232. Alternately, the UI 220 may be used to convert data stored in imaging device memory 214 into scanned image data. In another aspect, the imaging device 202 may have a facsimile interface 234, a memory stick (for example, USB) interface 236, or a web interface 238. Then, the scanning menu UI source command may choose a process that converts data into the scanned image data from a source such as a digital camera on line 218, facsimile format data downloads on line 234, memory stick data downloads on line 236, or web page data downloads on line 238.

Prior to composing the storage job build, the host 206 may perform a preliminary host-coupled process such as optical character recognition (OCR), encryption/decryption, annotation, or selective content removal. In another aspect, the host 206 may, in parallel with composing the storage job build, perform a process such as indexing and storing the scanned image data into a document server 240, sending the scanned image data to a website 242 for publication, or faxing the scanned image data to an imaging device-connected destination 244.

### Functional Description

Imaging Device User Interface

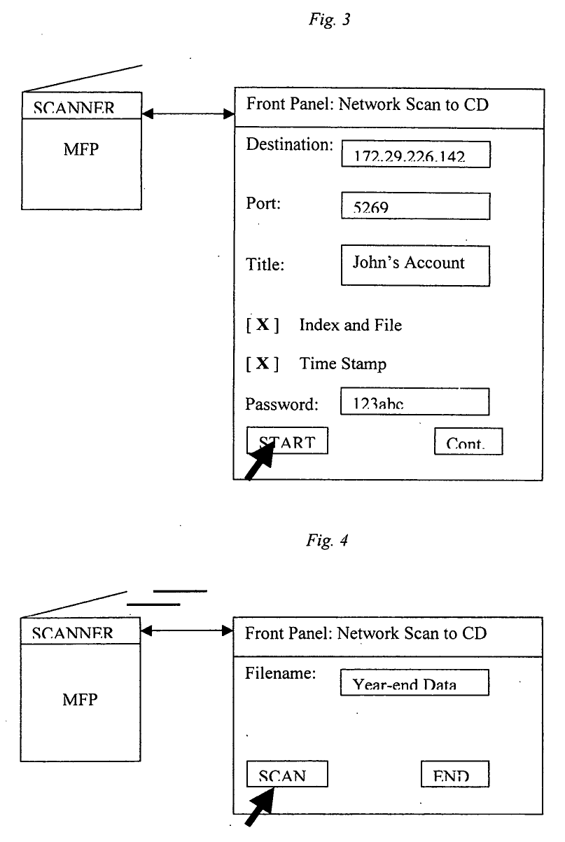

FIG. 3 is a depiction of an exemplary scanning menu user interface. The operator's panel (UI) for an imaging device, such as an MFP or standalone scanner, may have menu(s) for the network scan to removable storage media operation. The operator's panel may be, but is not limited to, a control panel on the MFP, such as a touch panel screen, or an external device attached to the MFP. For example, the external display device may be connected to the MFP via local or network port. Alternately, the scanning menu user interface may be a remote interface such as a web page interface.

The scanning menu UI may include user selections such as destination. The destination might be specified by network address (e.g., IP address), network name (e.g., DNS name), user profile (e.g., predetermined by specification in user profile), and a default setting preprogrammed into the device.

The UI may include a host build process, which might be further defined by port number (e.g., a port on which the build process writer is listening, user profile (e.g., predetermined by specification in user profile), or default (e.g., preprogrammed into device). The UI may include a volume information selection that may be further defined by title or time stamp.

An access control selection may include a password for file encryption, discretionary access based upon the public, a group, or a user categories for example. Access control may be defined with mandatory access criteria or compartmental mode access (e.g., metadata for read, write, copy, print operations).

A UI output format selection may define the scanned image data format, such as TIFF, JPEG, or PDF. The output format may also define a compression algorithm or resolution. A host coupling process may be selected, which processes the scanned image data, either serially or parallely. If serial, the output of a serial operation is used as part of the job building process. If parallel, the output of a parallel operation goes somewhere else, for example for use in a file/index operation. Auxiliary services can also be selected that might include coping, faxing, or saving the scanned image data in an image/document server.

A UI preview process may permit the user to select a subset of scanned images that are stored, downloaded or pre-scanned on the device. The UI preview process may permit the user to further crop the images and perform other image adjustments.

FIG. 4 is a depiction of source selection made from the scanning menu UI. Once the user has initiated the network scan-to-removable storage media process, for example, by depressing a UI menu “start scan” button, the user may initiate one or more scans. A scan may be, but is not necessarily limited to a single sheet input on the platen, a multi-sheet input (i.e., a document) on the document feeder, or scanned image(s) stored in, or accessible from, the MFP. For example, the images may be in an MFP memory or in an imaging device server. A facsimile input may be selected, or scanned image data input from other input devices, for example, from a digital camera memory stick or electronic whiteboard, to name a couple of examples.

The network scan-to-removable storage media process may also be coupled with other device operations. For example, all images/documents processed for the network scan may also be printed in parallel copy operation, or faxed to a destination.

For each scan operation, the user may enter additional information specific to the scan, from the scanning menu UI, such as, but not limited to, a filename for the scanned data, annotations, or overrides for other data, such as access control, encryption, or scanned data format.

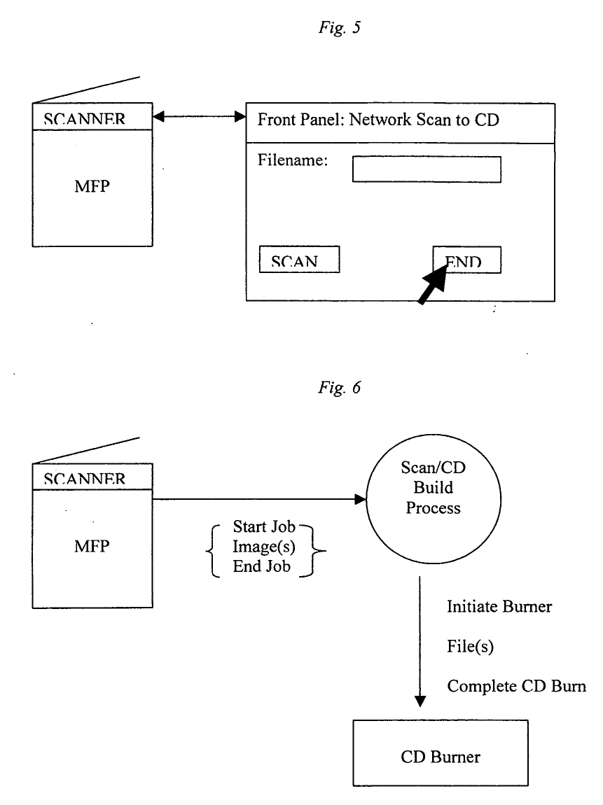

FIG. 5 is a depiction of “stop scan” scanning menu UI selection. Using a CD writer as an example, after the user has completed the input of all the scanned image data that comprises the network scan-to-CD, the user indicates the completion of the CD build by selecting the END control on the network scan-to-CD menu(s).

Communication between Imaging Device and Host

FIG. 6 is a depiction of a network scan-to-CD burn process. The imaging device, such as an MFP, may communicate with the host process either in batch mode, or synchronously. In the former, the MFP stores all the image data that is part of the build process, and does not send it to the host until the user indicates completion of the build. In the later case, the MFP sends the scanned image data to the host process as the data is produced by the MFP.

Generally, the communication between the MFP and the host build process consists of three components:

1. Start Job—information indicating the initiation of the start of the build process, which may include additional information, such as the volume information and host coupling selections.

2. Image(s)—the scanned image data segments which compose the build, which may include additional information, such as the filename for each scanned image data segment.

3. End Job—information indicating the completion (i.e., all scanned image data segments have been sent) of the build.

The build process on the host communicates to the writer, such as by a CD burner driver, to initiate and label a CD burn process, download the scanned image data to copy to the CD, and complete the CD burn process.

As mentioned above, during the production of the scanned image data by the MFP, the MFP may process the scanned image data before transmission to the host, with respect to output format, such as TIFF, JPEG, or PDF. Other pre-transmission processes may involve compression (such as G3, G4, or LZW), resolution, encryption, metadata insertion, cropping, or other MFP operations, such as copy, fax, or image store.

Host-Coupled Processes

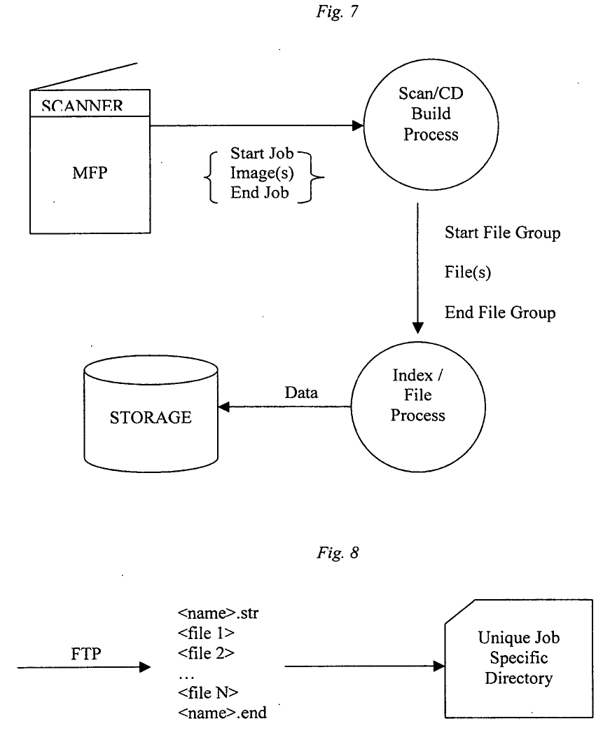

FIG. 7 is a diagram depicting an exemplary communication process associated with filing the scanned image data. The host CD burn process may also couple the received scanned image data for the storage job build to other host processes. The scanned image data may be further processed on the host before being stored as follows: OCR—conversion to textual representation, or content removal—removal (or other reduction) of selected content.

In other cases, a copy of the scanned image data is processed in parallel, and separately from storage job build process, such as, but not limited to: indexing and storing into a document server (e.g., account management system), or faxed to another destination. A job billing (e.g., charged for the number of scanned images burned to the CD) may also be performed.

Example Formats

The data and protocol formats used for communication between the imaging device and the host process may be in a number of forms. Some example forms are given below.

Built on Top of an Existing Communication Protocol

FIG. 8 depicts an FTP host communication process. In this example, the communication is built on top of an existing protocol, such as the file transfer protocol (FTP). Under this method, the control instructions are obtained from the data and not the protocol. For FTP, the group of images and instructions for the storage job build may be as follows. Place the scanned image data in a job-specific directory to indicate the grouping, and create a special file (e.g., <job name>.str) whose contents contains the storage job build instructions, such as the volume labeling information and optional host coupling. Each scanned image data is transferred as a file to the directory. Then, a special file is created (e.g., <job name>.end) to indicate when all the files have been transferred for the storage job build.

Proprietary Protocol

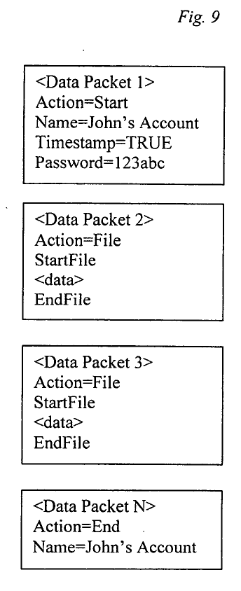

FIG. 9 depicts a proprietary host communication process. In this example, the communication is based on a proprietary data protocol. For example, the proprietary data protocol may be broken into data packets. Each data packet indicates the action type, such as:

1. Job Start—contains such information as volume label, password, host coupling, etc.

2. Image(s)—contains image data and associated file name

3. Job End—indicates the end of the job build.

The communication method may also be bidirectional, and be used by the host process to send a completion notification back to the imaging device indicating whether the storage operation is successful or not.

FIG. 10 is a drawing depicting an aspect where the host is embedded in the imaging device. The host process can partly or wholly enabled within the imaging device. For example, the storage job (CD) build process can be built into the MFP firmware. The MFP may include an industry standard CD burner driver, which can connect to a local port (e.g., serial, parallel, USB) on the MFP. An external CD burner is then connected to the local port. Alternately, the removable storage medium writer is built into the imaging device.

FIG. 11 is a flowchart illustrating a method for storing network-scanned data in a removable storage medium. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 1100.

Step 1102, prior to providing the scanned image data (Step 1104), accepts the scanned image data in a process such as accepting digital camera data or accessing scanned image data from imaging device storage. In Step 1104 an imaging device provides scanned image data. The imaging device providing the scanned image data may be a scanner, MFP, a fax device, digital camera, wireless telephone, or an electronic whiteboard. Step 1106 sends the scanned image data to a host. For example, the scanned image data can be sent in batch mode or synchronously. Further, the scanned image data can be sent to the host in a format such as file transfer protocol (FTP), email, extensible markup language/simple object access protocol (XML/SOAP), network file system, or a proprietary format. However, the method is not limited to any particular type of format. The scanned image data may be sent to a host that is the imaging device, an imaging device-connected apparatus such as a server, a computer, another imaging device, a digital camera, a personal digital assistant (PDA), a wireless telephone, or a tablet personal computer.

Step 1108, at the host, composes a storage job build from the scanned image data. Step 1110 sends the built storage job to a removable storage medium writer. Step 1110 sends the built storage job to the removable storage medium writer embedded in a device such as the imaging device, the host, and a device connected to the host. Step 1112 writes the built storage job on a removable storage medium such as a floppy disk, CD, DVD, ZIP, removable hard drive, or Flash memory. However, the invention is not limited to any particular type of medium.

In one aspect, providing scanned image data in Step 1104 includes substeps. Step 1104a accesses a scanning menu user interface (UI). Step 1104b accepts a scan start command. Step 1104c accepts a source command. Step 1104d accepts a scan stop command. The steps of sending the scanned image data (Step 1106), composing the storage job build (Step 1108), sending the built storage job (Step 1110), and writing the built storage job on the removable storage medium (Step 1112) are automatically initiated in response to accepting the scan stop command (Step 1104d).

In one aspect, accessing the scanning menu UI in Step 1104a includes accessing the UI from an operator's panel embedded in a device such as a front panel of the imaging device, a locally-connected external device, network-connected external device, a remotely-connected external device, or the host. In another aspect, Step 1104a accepts option selections such as destination, host build information, storage organization information, access control, compression format, encryption, output format, host coupling, or auxiliary services.

In a different aspect, Step 1105 chooses a process such as scanning a single sheet on an imaging device platen, or scanning a document from an imaging device feeder, in response to accepting the source command in Step 1104c. Alternately, Step 1105 converts (initiates a process that converts) data into the scanned image data from a source such as stored data, a digital camera, and downloads such as facsimile format data, a memory stick data, or web page data.

In one aspect a further step, Step 1107, prior to composing the storage job build (Step 1108), performs a preliminary host-coupled process such as OCR, encryption/decryption, annotation, or selective content removal. In a different aspect, Step 1109, in parallel with composing the storage job build, performs a process such as indexing and storing the scanned image data into a document server, sending the scanned image data to a website for publication, or faxing the scanned image data to an imaging device-connected destination.

A system and method have been provided for automatically writing a removable storage medium from a network scan. Generally, the invention has been described in the context of an MFP imaging device and CD burner writing device. However, the invention is not limited to merely this example. Other embodiments include implementing the processes on the Microsoft Windows Operating System, Apple MacIntosh Operating System, Linux Operating System, UNIX operating systems such as System V Unix Operating Systems, BSD Unix Operating Systems, OSF Unix Operating Systems, Sun Solaris Operating Systems, HP/UX Operating Systems, IBM AIX, and other operating systems such as IBM Mainframe MVS Operating System (OS/390) and IBM AS/400. However, the invention is not limited to any particular operating system. The host may be any personal computer, mini or mainframe computer, or a thin client such as a PDA, or tablet PC. Other variations and embodiments of the invention will occur to those skilled in the art.

As used herein, a host is a computer or microprocessor-driven device that acts as a source of information or signals. A host can be a centralized mainframe that is a host to its terminals, a server that is host to its clients, or a desktop personal computer (PC) that is host to its peripherals. In network architectures, a client station (user's machine) is also considered a host, because it is a source of information to the network, in contrast to a device such as a router or switch that directs traffic. Alternately stated, a host is a device accessed from a remote location. For example, the system that contains the data is called the host, while a connected computer can be a remote terminal.

We claim:

1. A method for storing network-scanned data in a removable storage medium, the method comprising:
an imaging device providing scanned image data;
sending the scanned image data to a host;
at the host, composing a storage job build from the scanned image data;
sending the built storage job to a removable storage medium writer; and,
writing the built storage job on a removable storage medium.

2. The method of claim 1 further comprising:
prior to providing the scanned image data, accepting the scanned image data in a process selected from the group accepting digital camera data, and accessing scanned image data from imaging device storage.

3. The method of claim 1 wherein writing the built storage job on a removable storage medium includes writing to a medium selected from the group including floppy disk, compact disk (CD), digital video disk (DVD), ZIP, removable hard drive, and Flash memory.

4. The method of claim 2 wherein providing scanned image data includes:
accessing a scanning menu user interface (UI);
accepting a scan start command;
accepting a source command; and,
accepting a scan stop command.

5. The method of claim 4 wherein the steps of sending the scanned image data, composing the storage job build, sending the built storage job, and writing the built storage job on the removable storage medium are automatically initiated in response to accepting the scan stop command.

6. The method of claim 4 wherein accessing the scanning menu UI includes accessing the UI from an operator's panel embedded in a device selected from the group including a front panel of the imaging device, a locally-connected external device, network-connected external device, a remotely-connected external device, and the host.

7. The method of claim 4 wherein accessing the scanning menu UI includes accepting option selections chosen from the group including destination, host build information, storage organization information, access control, compression format, encryption, output format, host coupling, and auxiliary services.

8. The method of claim 4 further comprising:
in response to accepting a source command, choosing a scanning process selected from the group including scanning a single sheet on an imaging device platen, scanning a document from an imaging device feeder, converting data into the scanned image data from a source such as stored data, a digital camera, and downloads such as facsimile format data, a memory stick data, and a web page data.

9. The method of claim 1 wherein sending the scanned image data to the host includes communicating in a manner selected from the group including batch mode and synchronously.

10. The method of claim 1 further comprising:
prior to composing the storage job build, performing a preliminary host-coupled process selected from the group including optical character recognition (OCR), encryption/decryption, annotation, and selective content removal.

11. The method of claim 1 further comprising:
in parallel with composing the storage job build, performing a process selected from the group including indexing and storing the scanned image data into a document server, sending the scanned image data to a website for publication, and faxing the scanned image data to an imaging device-connected destination.

12. The method of claim 1 wherein sending the scanned image data to the host includes communicating in a format selected from the group including file transfer protocol (FTP), email, XML/SOAP, network file system, and a proprietary format.

13. The method of claim 1 wherein sending the scanned image data to the host includes sending the scanned image data to a host selected from the group including the imaging device, an imaging device-connected apparatus such as a server, a computer, another imaging device, a digital camera, a personal digital assistant (PDA), a wireless telephone, and a tablet personal computer.

14. The method of claim 1 wherein providing the scanned image data includes providing the scanned image data from an imaging device selected from the group including a scanner, a multifunctional peripheral (MFP), a fax device, a digital camera, a wireless telephone, and an electronic whiteboard.

15. The method of claim 1 wherein sending the built storage job to the removable storage medium writer includes sending the built storage job to a writer embedded in a device selected from the group including the imaging device, the host, and a device connected to the host.

16. A system for storing network-scanned data in a removable storage medium, the system comprising:
an imaging device having an interface for sending scanned image data;
a host having an interface to receive the scanned image data, the host composing a storage job build from the scanned image data and sending the built storage job on an interface; and,
a writer accepting the built storage job on an interface and writing the built storage job on a removable storage medium.

17. The system of claim 16 wherein the imaging device includes a memory and a camera interface, and wherein the imaging device accepts the scanned image data in a process selected from the group accepting digital camera data, and accessing scanned image data from imaging device memory.

18. The system of claim 16 wherein writer is a device selected from the including floppy disk, compact disk (CD), digital video disk (DVD), ZIP, removable hard drive, and Flash memory writer.

19. The system of claim 17 further comprising:
a scanning menu user interface (UI) to enable command selections chosen from the group including scan start, source selection, and scan stop.

20. The system of claim 19 wherein the scanning menu UI accepts a scan stop command;
wherein the imaging device automatically sends the scanned image data to the host in response;
wherein the host automatically composes the storage job build and sends the built storage job in response to the scan stop command; and,
wherein the writer automatically writes the built storage job on the removable storage medium in response to the scan stop command.

21. The system of claim 19 further comprising:
a first device connected to the imaging device through an interface selected from the group including a local connection, a remote connection, and a network connection; and,
wherein the scanning menu UI is embedded in a device selected from the group including a front panel of the imaging device, the first device, and the host.

22. The system of claim 19 wherein the scanning menu UI enables option selections chosen from the group including destination, host build information, storage organization information, access control, compression format, encryption, output format, host coupling, and auxiliary services.

23. The system of claim 19 wherein the imaging device includes a platen, a feeder, a memory including stored data, a facsimile interface, a memory stick interface, and a web interface; and,
wherein the scanning menu UI source selection command chooses a process selected from the group including scanning a single sheet on the imaging device platen, scanning a document from the imaging device feeder, converting data into the scanned image data from a source such as stored data from the imaging device memory, a digital camera, facsimile format data downloads, memory stick data downloads, and web page data downloads.

24. The system of claim 16 wherein the imaging device sends the scanned image data to the host in a manner selected from the group including batch mode and synchronously.

25. The system of claim 16 wherein the host, prior to composing the storage job build, performs a preliminary host-coupled process selected from the group including optical character recognition (OCR), encryption/decryption, annotation, and selective content removal.

26. The system of claim 16 wherein the host, in parallel with composing the storage job build, performs a process selected from the group including indexing and storing the scanned image data into a document server, sending the scanned image data to a website for publication, and faxing the scanned image data to an imaging device-connected destination.

27. The system of claim 16 wherein the imaging device sends the scanned image data to the host in a format selected from the group including file transfer protocol (FTP), email, XML/SOAP, network file system, and a proprietary format.

28. The system of claim 16 wherein host is device selected from the group including the imaging device, an imaging device-connected apparatus such as a server, a computer, another imaging device, a digital camera, a personal digital assistant (PDA), a wireless telephone, and a tablet personal computer.

29. The system of claim 16 wherein the imaging device is a device selected from the group including a scanner, a multifunctional peripheral (MFP), a fax device, a digital camera, a wireless telephone, and an electronic whiteboard.

30. The system of claim 16 wherein the writer is embedded in a device selected from the group including the imaging device, the host, and a device connected to the host.
